(19) United States
(12) Patent Application Publication
(10) Pub. No.: US 2025/0092251 A1
(43) Pub. Date: Mar. 20, 2025

(54) MULTIPHASED POLYHYDROXYALKANOATE-BASED COMPOSITIONS AND ARTICLES MADE THEREFROM

(71) Applicant: Newlight Technologies, Inc., Huntington Beach, CA (US)

(72) Inventors: Jeffery Leon, Huntington Beach, CA (US); Scott William Wollack, Huntington Beach, CA (US)

(21) Appl. No.: 18/832,841

(22) PCT Filed: Feb. 13, 2023
(86) PCT No.: PCT/US2023/062494

§ 371 Date: Jul. 24, 2024

Related U.S. Application Data
(60) Provisional application No. 63/267,986, filed on Feb. 14, 2022.

(51) Int. Cl. C08L 67/04; A23L 29/00; A47G 21/18

(52) U.S. Cl. CPC C08L 67/04; A23L 29/035; A47G 21/18; C08L 2201/06; C08L 2205/025; C08L 2207/04

(57) ABSTRACT

The present specification generally relates to a composition for the manufacture of bio-degradable, bio-compostable, ocean degradable, biocompatible articles that contain a bio-based thermoplastic component. In particular, it has been found, in accordance with the practice of this invention, that marked improvement in tensile strength, toughness and elongation of polyhydroxyalkanoate (PHA) can be achieved by dispersing in the PHA an amorphous PHA and then optionally coupling the dispersed amorphous PHA. The polyhydroxyalkanoate/amorphous polyhydroxyalkanoate blends of the present invention comprise from 70-97.5 percent by weight of the PHA, from 2.5-30 percent by weight of the amorphous PHA can be used to produce a wide array of articles.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present specification generally relates to compositions of polymer blends of polyhydroxyalkanoate (PHA). In particular, the invention pertains to a composition and an article of manufacture having a continuous phase and a discrete phase wherein the continuous phase is made up of poly (3-hydroxybutyrate) homopolymer (PHB) and the discrete phase is an amorphous polyhydroxyalkanoate (aPHA) with a glass transition temperature (Tg) in the range of below 20° C. and a melting temperature (TM) of 80° C. to 180° C. More specifically, the present invention relates to a blend of two PHA materials wherein the continuous phase is between about 88%-97.5% of the total PHA and the discrete phase is between about 2.5 to about 30% of the total PHA. Methods of making the compositions of the invention are also described. The invention also includes articles and films comprising the compositions.

### BACKGROUND

In the first decade of this century, more plastic was produced than all the plastic in history up to the year 2000. The use of plastic materials on a large scale has represented a mark in the history of technological development; however, the increasing utilization of these materials is resulting in serious environmental problems. These materials, in general, take approximately 500-1,000 years to degrade naturally, meaning that virtually every piece of synthetic plastic ever made still exists today in some shape or form. In the case of petrochemical-derived plastic resins, approximately 900 billion pounds worldwide are produced annually and it is estimated that this number will continue to increase each year by approximately four percent. Of this annual worldwide production, it is estimated that approximately 10 percent or 90 billion pounds enters the earth's oceans on an annual basis, resulting in the deaths of thousands of seabirds and sea turtles, seals and other marine mammals each year after either ingesting the plastic or getting entangled in it.

In view of these problems, more than 60 countries have introduced levies and bans to combat single-use plastic waste, according to the U.N. Environment, an agency of the United Nations. Considering the relevance of these facts, the market potential for using these new materials is enormous and biodegradable plastic resins are receiving worldwide attention. The applications for these biodegradable biopolymers in the market involve products, such as disposable materials, including but not limited to packaging, diapers, dishware, drinkware, cutlery; cosmetic, agrochemical and aquatic products; and medical and pharmaceutical articles, such as microencapsulating drugs of controlled release, medical sutures and fixation pins for bone fractures, due to their total biocompatibility and mild rejection from the receiving organism.

An important family of the biodegradable biopolymers are polyhydroxyalkanoates (PHAs), which are polyesters naturally synthesized by over 300 different microorganisms, serving as natural energy reserves for the microbe. One of the simplest and most important polymers in the PHA biopolymer family is polyhydroxybutyrate (PHB). The commercial interest in PHBs is directly related not only to the biodegradability and biocompatibility characteristics but also to their thermo-mechanical properties and production costs. In addition, there is a growing body of evidence that PHBs, when ingested by an animal, can act as microbial control agents of the gut flora, which may have a positive impact on weight gain, growth rate and overall survival (Y. Duan, et al., Effect of dietary poly-□-hydroxybutyrate (PHB) on growth performance, intestinal health status and body composition of Pacific white shrimp Litopenaeus vannamei, Fish & Shellfish Immunology, 60:520-528 (2017); and E. H. Najdegerami, et al., Effects of poly-□-hydroxybutyrate (PHB) on Siberian sturgeon (Acipenser baerii) fingerlings performance and its gastrointestinal tract microbial community, FEMS Microbiol Ecol., 79:25-33 (2012).

These thermoplastic or elastic polyesters may be conveniently synthesized by cultivating a wide variety of microorganisms, bacteria in particular, in an aqueous medium on a carbon source, including sugars, alkanes, vegetable oils, organic acids, and alcohols. Depending on the microorganism, carbon source, nutrients and culture conditions, the PHA, typically stored inside of the cell as discrete amorphous, water insoluble granules can be difficult to isolate and purify. Once isolated, PHAs and specifically PHB's further suffer from brittleness, due to their semi-crystalline nature and thermal instability. One route to overcome the inherent brittleness of PHB and toughen the PHB is by using copolymers, which have low levels of valerate. However, these copolymers exhibit a lower melting point than PHB and so narrowing the utilization temperature range of the composition. Alternatively, the incorporation of rubber particles into a brittle thermoplastic matrix is known to improve the impact properties and the toughness of the polymer (Amos, J. L., et al., U.S. Pat. No. 2,694,692 (1954); and Baer, et al., U.S. Pat. No. 4,306,040 (1981)). Under proper conditions and using appropriate compatibilizers, synergistic effects arise to create high impact toughened polymer blends for high-value durable applications. But, adding low modulus rubber particles to the polymer lowers the stiffness and strength and this reduction in rigidity significantly lowers the scratch/mar resistance of the resulting blends. Hence, to overcome this brittleness, high modulus fillers like clay are also incorporated into the toughened blend which, with optimal processing and chemistry, can regain this lost strength and stiffness.

Thus a need exists for improving the durability, the toughness and impact strength of PHA's without the use of fillers such as clay and without compromising PHA's inherent stiffness, strength ability to biodegrade and its nutritional value.

### SUMMARY

The present invention addresses a need for improving the durability, the toughness and impact strength of PHA's without compromising its inherent stiffness, strength, ability to biodegrade.

The present invention further provides PHA polymer composites which are relatively inexpensive and easy to manufacture.

In general, the present invention describes an environmentally sustainable composition that is useful for the manufacture of polyhydroxyalkanoate-based articles. In particular, the invention pertains to an article of manufacture having a continuous phase and a discrete phase wherein the continuous phase is made up of poly (3-hydroxybutyrate) homopolymer (PHB) and the discrete phase is an amorphous polyhydroxyalkanoate (PHA).

The novel blended polyhydroxyalkanoate composition of the present invention may comprise a mixture of two polymers, (i) a PHB and (ii) amorphous polyhydroxyalkanoate (aPHA), in combination with a peroxide and a co-agent. Preferably, the composition of the present invention, which is biodegradable and biocompatible, comprises about 88% to about 97.5% by weight PHB and between about 2.5 to about 30% aPHA of the total PHA.

The novel blended polyhydroxyalkanoate compositions can be made by any suitable method, using any suitable order of processing. For example, in one embodiment, the method comprises the steps of: (a) mixing, in a molten state, the PHA polymers in combination with a peroxide and a co-agent to form a homogenous blend; and (b) cooling the homogenous blend to form a solid PHB/aPHA polymer composition, which can then be shaped into an article. Any suitable polymer processing equipment can be used such as, for example, an extruder (e.g., single screw or twin screw) or injection molding equipment. The methods can additionally comprise other steps, such as strand preparation, color addition, pelletizing and homogenizing.

In another embodiment, the PHA polymers are in the form of a fine particle size powder, and blended by dry-blending the components at a pre-determined ratio, mixed and processed. Again, any suitable processing equipment can be used, such as, for example, an extruder (e.g., single screw or twin screw). The methods can additionally comprise other steps, such as strand preparation, color addition, pelletizing and homogenizing the polyhydroxyalkanoate/amorphous polyhydroxyalkanoate blend.

The novel blended polyhydroxyalkanoate compositions of this invention can be fabricated into commercially useful articles, such as, but not limited to film, sheets, multi-layer structures, fiber, monofilaments, sheets, thermoformed articles, blow-molded articles, injection molded articles, and injection stretch blow molding etc. Also provided herein are articles made from any of the blended compositions of the invention.

Optionally, additives may be added to the novel blended composition. Such additives may be mixed at a suitable time during the processing of the components for forming the blend composition. One or more additives are included in the blended compositions to impart one or more selected functional characteristics to the blended compositions and any molded article made therefrom. Examples of additives that may be included in the present invention include, but are not limited to, heat stabilizers, process stabilizers, light stabilizers, antioxidants, slip/antiblock agents, pigments, UV absorbers, fillers, lubricants, pigments, dyes, colorants, flow promoters plasticizers, processing aids, branching agents, strengthening agents, nucleating agents (discussed in further detail below), talc, wax, calcium carbonate, radical scavengers or a combination of one or more of the foregoing functional additives.

The fabricated articles of manufacture, as a waste product entering the environment, may then be degraded into monomeric units (PHA's are not degraded into short chain fatty acids.—which have been shown to be beneficial to growth performance, intestinal digestive, and immune function.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### DETAILED DESCRIPTION

The present specification generally relates to a composition for the manufacture of bio-degradable, bio-compostable, ocean degradable, biocompatible articles that contain a bio-based thermoplastic component. In particular, it has been found, in accordance with the practice of this invention, that marked improvement in toughness and elongation of polyhydroxyalkanoate (PHA) can be achieved by dispersing in the PHA, and more specifically PHB, an amorphous polyhydroxyalkanoate (aPHA) with a glass transition temperature of below 20° C. and then optionally coupling the two PHA molecules. The polyhydroxyalkanoate blends of this invention comprise a continuous phase made up of poly (3-hydroxybutyrate) homopolymer (PHB) and a discrete phase made up of an amorphous polyhydroxyalkanoate (aPHA) with a glass transition temperature (Tg) below 20° C. and a melting temperature (TM) of 80° C. to 180° C. More specifically, the present invention relates to a blend of two PHA materials wherein the continuous phase (PHA) is between about 88%-97.5% of the total PHA and the discrete phase (aPHA) is between about 2.5 to about 30% of the total PHA. Peroxide and a co-agent can then be further added to this blend to enhance its toughness.

The two polymers, PHA and aPHA, which are employed in forming the blended polyhydroxyalkanoate composition of the present invention are discussed in further detail below and may include homopolymers, copolymers, and blends thereof. Suitable compatibilizers of the invention include, but are not limited to polypropylene-co-acrylic acids, polypropylene-g-maleic anhydride, polyethylene-g-maleic anhydride, polyethylene-g-maleic anhydride-co-ethyl acrylate, polyethylene-g-maleic anhydride-co-methyl acrylate, polyethylene-co-butylene/styrene, polyethylene-co-butylene/succinic anhydride, polyethylene-co-acrylic acid, polyethylene-co-methyl acrylate, polyurethanes, thermoplastic polyurethanes, thermoplastic polyesters, thermoplastic polyethers, thermoplastic polyether esters, thermoplastic polyol/copolyol polyethylene-co-butyl acrylate, thermoplastic polycaprolactones, polybasic acids, polyglycols, substituted fatty acids, polyester adipates, succinic polyesters, polyoxyalkylenes, polypropylene adipate, polyester glutarate, polyethylene glycol monooleate, trimethylcitrate, epoxidized soyabean oil, acetyl tri-n-butyl citrate, polyester sebacate, neopentylglycol-adipicacid-caprolactone, trifunctional polyester adipates, epoxidized linseed oil, castor oil, and glutaric polyesters, allowing for the formation of a blended composition having two discrete phases. Surprisingly, the inventors have discovered that multi-phase block co-polymers are uniquely qualified to aid in the miscibility of the aPHA and PHA polymer, thus allowing for the formation of a blended composition useful in the manufacture of bio-degradable, ocean degradable and bio-compostable articles with adequate strength and durability. Added benefits of the blended polyhydroxyalkanoate/amorphous PHA composition are that it is bio-degradable, ocean degradable, bio-compostable, and bio-compatible. The blended composition, as an article of manufacture will eventually degrade in the environment releasing natural PHA polymer residue, such as but not limited to poly-3-hydroxybutyrate (PHB) that may then be decomposed into water-soluble short-chain fatty acid monomer which have been shown to be beneficial to growth performance, intestinal digestive and immune function in animal studies.

The mechanism for the miscibility of this polymer-polymer interface is believed to be due to increased intermolecular forces between polymer chains thereby reducing interfacial tension and allowing the formation of desirable phase morphology. While not intending to be bound by any particular theory, possible factors that influence the miscibility include molecular weight, molecular weight distribution, hydrogen bonding, vander Waals forces, dielectric constant, polarity of the chains (dipole moment), end-groups, and the purity of the polymers. It is believed that the multi-phase block copolymer reduces the interfacial tension between that of the PHA polymer and the amorphous polyhydroxyalkanoate.

The novel blended compositions disclosed herein comprises: (a) from about 68 percent by weight to about 97.5 percent by weight PHA and (b) from about 2.5 percent by weight to about 32 percent by weight amorphous PHA. It has been discovered that the desired properties can be tuned by varying the concentration of the components. For example, formulations having from about 68 percent by weight to about 97.5 percent by weight PHA and (b) from about 2.5 percent by weight to about 32 percent by weight aPHA will have mechanical properties which are good for cutlery. Cutlery products, in general, require increased stiffness, strength, stability, color capability, easy processability, moldability, disposability, ocean degradability, biodegradability and biocompostability. In the event a more durable product is required for manufactured parts such as electrical, electronic and computer parts applications formulations having from about 68 percent by weight to about 97.5 percent by weight PHA and from about 2.5 percent by weight to about 32 percent by weight aPHA, and more preferably 86 percent by weight to about 96.5 percent by weight PHA and from about 2.5 percent by weight to about 10 percent by weight can be prepared. Optionally, additives such as, but not limited to, colorants, nucleating agents, stabilizers, coupling agents, free radical initiators, and strengthening agents may be added to the blended composition of the present invention. The additives contemplated are described in further detail below.

It is to be understood that throughout this specification when PHA is referred to it is contemplated that these terms include homopolymers, copolymers, and blends thereof, that may or may not be food grade. As used herein, the terms “functional properties” and “functional characteristics” shall be given their ordinary meanings and shall also refer to the specification, features, qualities, traits, or attributes of PHA. The functional characteristics of the PHA include, but are not limited to molecular weight, polydispersity and/or polydispersity index, melt flow and/or melt index, monomer composition, co-polymer structure, melt index, non-PHA material concentration, purity, impact strength, density, specific viscosity, viscosity resistance, acid resistance, mechanical shear strength, flexural modulus, elongation at break, freeze-thaw stability, processing conditions tolerance, shelf-life/stability, hygroscopicity, and color. As used herein, the term “polydispersity index” (or PDI), shall be given its ordinary meaning and shall be considered a measure of the distribution of molecular mass of a given polymer sample (calculated as the weight average molecular weight divided by the number average molecular weight). The fully amorphous PHAs (having 0% crystallinity and no observed melting point temperature) and mostly amorphous phase PHAs includes polymers of 4-hydroxybutyrate, 3-hydroxyhexanoate, 5-hydroxyvalerate, 3-hydroxyhexanoate, 3-hydroxyoctanoate, or other 3-hydroxy alkanoic acids with higher numbers of carbons as pendant groups including those derived from fatty acids and combinations thereof. The resultant PHA can be a blend, copolymer, mixture or combination of one, two or three or more PHA components. Without intending to be limited to a specific theory, the inventors theorize that when the aPHA polymer is blended with other polymers, it readily forms a separate discrete phase which imparts a toughening effect on the overall polymer blend.

Polyhydroxyalkanoates are biological polyesters synthesized by a broad range of natural and genetically engineered microorganisms and microorganism enzymes as well as genetically engineered plant crops (Braunegg, et al., J. Biotechnology, 65:127-161 (1998); Madison and Huisman, Microbiology and Molecular Biology Reviews, 63:21-53 (1999); Poirier, Progress in Lipid Research 41:131-155 (2002)). These polymers are biodegradable thermoplastic materials, can be produced from renewable resources, and have the potential for use in a broad range of industrial applications (Williams & Peoples, CHEMTECH 26:38-44 (1996)). Useful microbial strains for producing PHAs, include Alcaligenes eutrophus (renamed as Ralstonia eutropha), Alcaligenes latus, Azotobacter, Aeromonas, Comamonas, Pseudomonads, and genetically engineered organisms including genetically engineered microbes such as Pseudomonas, Ralstonia and Escherichia coli.

In general, PHA is formed by enzymatic polymerization of one or more monomer units. Over 100 different types of monomers have been incorporated into the PHA polymers (Steinbuchel and Valentin, FEMS Microbiol. Lett., 128:219-228 (1995). Examples of monomer units incorporated in PHAs include 2-hydroxybutyrate, lactic acid, glycolic acid, 3-hydroxybutyrate (hereinafter referred to as 3HB), 3-hydroxypropionate (hereinafter referred to as 3HP), 3-hydroxyvalerate (hereinafter referred to as 3HV), 3-hydroxyhexanoate (hereinafter referred to as 3HH), 3-hydroxyheptanoate (hereinafter referred to as 3HHep), 3-hydroxyoctanoate (hereinafter referred to as 3HO), 3-hydroxynonanoate (hereinafter referred to as 3HN), 3-hydroxydecanoate (hereinafter referred to as 3HD), 3-hydroxydodecanoate (hereinafter referred to as 3HDd), 4-hydroxybutyrate (hereinafter referred to as 4HB), 4-hydroxyvalerate (hereinafter referred to as 4HV), 5-hydroxyvalerate (hereinafter referred to as 5HV), and 6-hydroxyhexanoate (hereinafter referred to as 6HH). 3-hydroxyacid monomers incorporated into PHAs are the (D) or (R) 3-hydroxyacid isomer with the exception of 3HP which does not have a chiral center.

The terms “PHA”, “PHAs”, and “polyhydroxyalkanoate”, as used herein, shall be given their ordinary meaning and shall include, but not be limited to, polymers generated by microorganisms or microorganism enzymes; biodegradable and/or biocompatible polymers that can be used as alternatives to petrochemical-based plastics such as polypropylene, polyethylene, and polystyrene; polymers produced by bacterial fermentation of sugars, lipids, or gases; thermoplastic or elastomeric materials derived from microorganisms or microorganism-derived enzymes; and/or polymers generated by chemical reaction not inside of microbial cell walls. PHAs include, but are not limited to, polyhydroxybutyrate (PHB), polyhydroxyvalerate (PHV), polyhydroxybutyrate-covalerate (PHBV), polyhydroxyhexanoate (PHHx) and blends thereof as discussed in detail below, as well as both short chain length (SCL), medium chain length (MCL), and long chain length (LCL) PHAs.

In some embodiments, the PHA is a homopolymer (all monomer units are the same). Examples of PHA homopolymers include poly 3-hydroxyalkanoates (e.g., poly 3-hydroxypropionate (hereinafter referred to as P3HP), poly 3-hydroxybutyrate (hereinafter referred to as PHB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)).

In certain embodiments, the starting PHA is a copolymer (containing two or more different monomer units) in which the different monomers are randomly distributed in the polymer chain. Examples of PHA copolymers include poly 3-hydroxybutyrate-co-3-hydroxypropionate (hereinafter referred to as PHB3HP), poly 3-hydroxybutyrate-co-4-hydroxybutyrate (hereinafter referred to as PHB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV).

By selecting the monomer types and controlling the ratios of the monomer units in a given PHA copolymer a wide range of material properties can be achieved. Although examples of PHA copolymers having two different monomer units have been provided, the PHA can have more than two different monomer units (e.g., three different monomer units, four different monomer units, five different monomer units, six different monomer units). An example of a PHA having 4 different monomer units would be PHB-co-3HH-co-3HO-co-3HD or PHB-co-3-HO-co-3HD-co-3HDd (these types of PHA copolymers are hereinafter referred to as PHB3HX). Typically where the PHB3HX has 3 or more monomer units the 3HB monomer is at least 70% by weight of the total monomers, preferably 85% by weight of the total monomers, most preferably greater than 90% by weight of the total monomers for example 92%, 93%, 94%, 95%, 96% by weight of the copolymer and the HX comprises one or more monomers selected from 3HH, 3HO, 3HD, 3HDd.

The homopolymer (where all monomer units are identical) PHB and 3-hydroxybutyrate copolymers (PHB3HP, PHB4HB, PHB3HV, PHB4HV, PHB5HV, PHB3HHP, hereinafter referred to as PHB copolymers) containing 3-hydroxybutyrate and at least one other monomer are of particular interest for commercial production and applications. It is useful to describe these copolymers by reference to their material properties as follows. Type 1 PHB copolymers typically have a glass transition temperature (Tg) in the range of 6° C. to −10° C., and a melting temperature Tm of between 80° C. to 180° C. Type 2 PHB copolymers typically have a Tg of −20° C. to −50° C. and Tm of 55° C. to 90° C. and are based on PHB4HB, PHB5HV polymers with more than 15% 4HB, SHV, 6HH content or blends thereof. In particular embodiments, the Type 2 copolymer have a phase component with a Tg of −15° C. to −45° C. and no Tm.

As used in the present invention, the molecular weight of PHA ranges between about 5,000,000 and about 2,500,000 Daltons, between about 2,500,000 and about 1,000,000 Daltons, between about 1,000,000 and about 750,000 Daltons, between about 750,000 and about 500,000 Daltons, between about 500,000 and about 250,000 Daltons, between about 250,000 and about 100,000 Daltons, between about 100,000 and about 50,000 Daltons, between about 50,000 and about 10,000 Daltons, and overlapping ranges thereof.

In determining the molecular weight, techniques such as gel permeation chromatography (GPC) can be used. In the methodology, a polystyrene standard is utilized.

The PHA can have a polystyrene equivalent weight average molecular weight (in Daltons) of at least 500, at least 10,000, or at least 50,000 and/or less than 2,000,000, less than 1,000,000, less than 1,500,000, and less than 800,000. In certain embodiments, preferably, the PHAs generally have a weight-average molecular weight in the range of 100,000 to 700,000. For example, the molecular weight range for PHB and Type 1 PHB copolymers for use in this application are in the range of 200,000 Daltons to 1.5 million Daltons as determined by GPC method and the molecular weight range for Type 2 PHB copolymers for use in the application 20,000 to 1.5 million Daltons.

In certain embodiments, the branched PHA, as discussed in further detail below, can have a linear equivalent weight average molecular weight of from about 150,000 Daltons to about 500,000 Daltons and a polydispersity index of from about 1.0 to about 8.0. As used herein, weight average molecular weight and linear equivalent weight average molecular weight are determined by gel permeation chromatography, using, e.g., chloroform as both the eluent and diluent for the PHA samples. Calibration curves for determining molecular weights are generated using linear polystyrenes as molecular weight standards and a ‘log MW vs. elution volume’ calibration method.

PHAs for use in the methods, compositions and pellets described in this invention are selected from PHB; a PHA blend of PHB with a Type 1 PHB copolymer where the PHB content by weight of PHA in the PHA blend is in the range of 20% to 99% by weight of the PHA in the PHA blend; a PHA blend of PHB with a Type 2 PHB copolymer where the PHB content by weight of the PHA in the PHA blend is in the range of 20% to 99% by weight of the PHA in the PHA blend; a PHA blend of a Type 1 PHB copolymer with a different Type 1 PHB copolymer and where the content of the first Type 1 PHB copolymer is in the range of 20% to 99% by weight of the PHA in the PHA blend; a PHA blend of a Type 1 PHB copolymer with a Type 2 PHA copolymer where the content of the Type 1 PHB copolymer is in the range of 20% to 99% by weight of the PHA in the PHA blend; a PHA blend of PHB with a Type 1 PHB copolymer and a Type 2 PHB copolymer where the PHB content is in the range of 20% to 99% by weight of the PHA in the PHA blend, where the Type 1 PHB copolymer content is in the range of 20% to 99% by weight of the PHA in the PHA blend and where the Type 2 PHB copolymer content is in the range of 20% to 99% by weight of the PHA in the PHA blend.

The PHA blend of PHB with a Type 1 PHB copolymer is a blend of PHB with PHB3HP where the PHB content in the PHA blend is in the range of 20% to 99% by weight of the PHA in the PHA blend and the 3HP content in the PHB3HP is in the range of 7% to 15% by weight of the PHB3HP.

The PHA blend of PHB with a Type 1 PHB copolymer is a blend of PHB with PHB3HV where the PHB content of the PHA blend is in the range of 20% to 99% by weight of the PHA in the PHA blend and the 3HV content in the PHB3HV is in the range of 4% to 22% by weight of the PHB3HV.

The PHA blend of PHB with a Type 1 PHB copolymer is a blend of PHB with PHB4HB where the PHB content of the PHA blend is in the range of 20% to 99% by weight of the PHA in the PHA blend and the 4HB content in the PHB4HB is in the range of 4% to 15% by weight of the PHB4HB.

The PHA blend of PHB with a Type 1 PHB copolymer is a blend of PHB with PHB4HV where the PHB content of the PHA blend is in the range of 20% to 99% by weight of the PHA in the PHA blend and the 4HV content in the PHB4HV is in the range of 4% to 15% by weight of the PHB4HV.

The PHA blend of PHB with a Type 1 PHB copolymer is a blend of PHB with PHB5HV where the PHB content of the PHA blend is in the range of 20% to 90% by weight of the PHA in the PHA blend and the 5HV content in the PHB5HV is in the range of 4% to 15% by weight of the PHB5HV.

The PHA blend of PHB with a Type 1 PHB copolymer is a blend of PHB with PHB3HH where the PHB content of the PHA blend is in the range of 20% to 90% by weight of the PHA in the PHA blend and the 3HH content in the PHB3HH is in the range of 4% to 15% by weight of the PHB3HH.

The PHA blend of PHB with a Type 1 PHB copolymer is a blend of PHB with PHB3HX where the PHB content of the PHA blend is in the range of 20% to 90% by weight of the PHA in the PHA blend and the 3HX content in the PHB3HX is in the range of 4% to 15% by weight of the PHB3HX.

The PHA blend is a blend of a Type 1 PHB copolymer selected from the group PHB3HV, PHB3HP, PHB4HB, PHBV, PHV4HV, PHB5HV, PHB3HH and PHB3HX with a second Type 1 PHB copolymer which is different from the first Type 1 PHB copolymer and is selected from the group PHB3HV, PHB3HP, PHB4HB, PHBV, PHV4HV, PHB5HV, PHB3HH and PHB3HX where the content of the First Type 1 PHB copolymer in the PHA blend is in the range of 20% to 99% by weight of the total PHA in the blend.

The PHA blend of PHB with a Type 2 PHB copolymer is a blend of PHB with PHB4HB where the PHB content in the PHA blend is in the range of 20% to 99% by weight of the PHA in the PHA blend and the 4HB content in the PHB4HB is in the range of 20% to 60% by weight of the PHB4HB.

The PHA blend of PHB with a Type 2 PHB copolymer is a blend of PHB with PHB5HV where the PHB content in the PHA blend is in the range of 20% to 99% by weight of the PHA in the PHA blend and the 5HV content in the PHB5HV is in the range of 20% to 60% by weight of the PHB5HV.

The PHA blend of PHB with a Type 2 PHB copolymer is a blend of PHB with PHB3HH where the PHB content in the PHA blend is in the range of 20% to 99% by weight of the PHA in the PHA blend and the 3HH content in the PHB3HH is in the range of 35% to 90% by weight of the PHB3HX.

The PHA blend of PHB with a Type 2 PHB copolymer is a blend of PHB with PHB3HX where the PHB content in the PHA blend is in the range of 20% to 99% by weight of the PHA in the PHA blend and the 3HX content in the PHB3HX is in the range of 35% to 90% by weight of the PHB3HX.

The PHA blend is a blend of PHB with a Type 1 PHB copolymer and a Type 2 PHB copolymer where the PHB content in the PHA blend is in the range of 20% to 99% by weight of the PHA in the PHA blend, the Type 1 PHB copolymer content of the PHA blend is in the range of 20% to 99% by weight of the PHA in the PHA blend and the Type 2 PHB copolymer content in the PHA blend is in the range of 20% to 99% by weight of the PHA in the PHA blend.

For example a PHA blend can have a PHB content in the PHA blend in the range of 20% to 99% by weight of the PHA in the PHA blend, a PHB3HV content in the PHA blend in the range 20% to 99% by weight of the PHA in the PHA blend, where the 3HV content in the PHB3HV is in the range of 3% to 22% by weight of the PHB3HV, and a PHBHX content in the PHA blend in the range of 20% to 99% by weight of the PHA in the PHA blend where the 3HX content in the PHBHX is in the range of 35% to 90% by weight of the PHBHX.

For example a PHA blend can have a PHB content in the PHA blend in the range of 20% to 99% by weight of the PHA in the PHA blend, a PHB3HV content in the PHA blend in the range 20% to 99% by weight of the PHA in the PHA blend, where the 3HV content in the PHB3HV is in the range of 3% to 22% by weight of the PHB3HV, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB3HV content in the PHA blend in the range 5% to 90% by weight of the PHA in the PHA blend, where the 3HV content in the PHB3HV is in the range of 3% to 22% by weight of the PHB3HV, and a PHB5HV content in the PHA blend in the range of 20% to 99% by weight of the PHA in the PHA blend where the 5HV content in the PHB5HV is in the range of 20% to 60% by weight of the PHB5HV.

For example a PHA blend can have a PHB content in the PHA blend in the range of 20% to 99% by weight of the PHA in the PHA blend, a PHB4HB content in the PHA blend in the range 20% to 99% by weight of the PHA in the PHA blend, where the 4HB content in the PHB4HB is in the range of 4% to 15% by weight of the PHB4HB, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB4HB content in the PHA blend in the range 20% to 99% by weight of the PHA in the PHA blend, where the 4HB content in the PHB4HB is in the range of 4% to 15% by weight of the PHB4HB, and a PHB5HV content in the PHA blend in the range of 20% to 99% by weight of the PHA in the PHA blend and where the 5HV content in the PHB5HV is in the range of 30% to 90% by weight of the PHB5HV.

For example a PHA blend can have a PHB content in the PHA blend in the range of 20% to 99% by weight of the PHA in the PHA blend, a PHB4HB content in the PHA blend in the range 20% to 99% by weight of the PHA in the PHA blend, where the 4HB content in the PHB4HB is in the range of 4% to 15% by weight of the PHB4HB, and a PHB3HX content in the PHA blend in the range of 20% to 99% by weight of the PHA in the PHA blend and where the 3HX content in the PHB3HX is in the range of 35% to 90% by weight of the PHB3HX.

For example a PHA blend can have a PHB content in the PHA blend in the range of 20% to 99% by weight of the PHA in the PHA blend, a PHB4HV content in the PHA blend in the range 20% to 99% by weight of the PHA in the PHA blend, where the 4HV content in the PHB4HV is in the range of 3% to 15% by weight of the PHB4HV, and a PHB5HV content in the PHA blend in the range of 20% to 99% by weight of the PHA in the PHA blend where the 5HV content in the PHB5HV is in the range of 30% to 90% by weight of the PHB5HV.

For example a PHA blend can have a PHB content in the PHA blend in the range of 20% to 99% by weight of the PHA in the PHA blend, a PHB3HH content in the PHA blend in the range 20% to 99% by weight of the PHA in the PHA blend, where the 3HH content in the PHB3HH is in the range of 3% to 15% by weight of the PHB3HH, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB3HH content in the PHA blend in the range 20% to 99% by weight of the PHA in the PHA blend, where the 3HH content in the PHB3HH is in the range of 3% to 15% by weight of the PHB3HH, and a PHB5HV content in the PHA blend in the range of 20% to 99% by weight of the PHA in the PHA blend where the 5HV content in the PHB5HV is in the range of 20% to 60% by weight of the PHB5HV.

For example a PHA blend can have a PHB content in the PHA blend in the range of 20% to 99% by weight of the PHA in the PHA blend, a PHB3HH content in the PHA blend in the range 20% to 99% by weight of the PHA in the PHA blend, where the 3HH content in the PHB3HH is in the range of 3% to 15% by weight of the PHB3HH, and a PHB3HX content in the PHA blend in the range of 20% to 99% by weight of the PHA in the PHA blend where the 3HX content in the PHB3HX is in the range of 35% to 90% by weight of the PHB3HX.

For example a PHA blend can have a PHB content in the PHA blend in the range of 20% to 99% by weight of the PHA in the PHA blend, a PHB3HX content in the PHA blend in the range 20% to 99% by weight of the PHA in the PHA blend, where the 3HX content in the PHB3HX is in the range of 3% to 12% by weight of the PHB3HX, and a PHB3HX content in the PHA blend in the range of 20% to 99% by weight of the PHA in the PHA blend where the 3HX content in the PHB3HX is in the range of 35% to 90% by weight of the PHB3HX.

For example a PHA blend can have a PHB content in the PHA blend in the range of 20% to 99% by weight of the PHA in the PHA blend, a PHB3HX content in the PHA blend in the range 20% to 99% by weight of the PHA in the PHA blend, where the 3HX content in the PHB3HX is in the range of 3% to 12% by weight of the PHB3HX, and a PHB4HB content in the PHA blend in the range of 20% to 99% by weight of the PHA in the PHA blend where the 4HB content in the PHB4HB is in the range of 20% to 60% by weight of the PHB4HB.

For example a PHA blend can have a PHB content in the PHA blend in the range of 20% to 99% by weight of the PHA in the PHA blend, a PHB3HX content in the PHA blend in the range 20% to 99% by weight of the PHA in the PHA blend, where the 3HX content in the PHB3HX is in the range of 3% to 12% by weight of the PHB3HX, and a PHB5HV content in the PHA blend in the range of 20% to 99% by weight of the PHA in the PHA blend where the 5HV content in the PHB5HV is in the range of 20% to 60% by weight of the PHB5HV.

As discussed above, the novel blended polyhydroxyalkanoate/amorphous polyhydroxyalkanoate composition of the present invention comprising blends of polyhydroxyalkanoate and amorphous polyhydroxyalkanoate. Optionally additives such as those disclosed below may be used to further change the desired properties of the blended composition of the present invention.

### Additives

In certain embodiments, various additives are added to the novel blended composition. Such additives may be mixed at a suitable time during the processing of the components for forming the composition. The one or more additives are included in the blended compositions to impart one or more selected characteristics to the blended compositions and any molded article made therefrom. Examples of additives that may be included in the present invention include, but are not limited to, heat stabilizers, process stabilizers, light stabilizers, antioxidants, slip/antiblock agents, pigments, UV absorbers, fillers, lubricants, pigments, dyes, colorants, flow promoters plasticizers, nucleating agents (discussed in further detail below), talc, wax, calcium carbonate radical scavengers or a combination of one or more of the foregoing additives. The branching agent and/or coupling agent is added to one or more of these for easier incorporation into the polymer. For instance, the branching agent and/or coupling agent is mixed with a plasticizer, e.g., a non-reactive plasticizer, e.g., a citric acid ester, and then compounded with the polymer under conditions to induce branching. Examples of suitable fillers include but are not limited to glass fibers and minerals such as precipitated calcium carbonate, ground calcium carbonate, talc, wollastonite, alumina trihydrate, wood flour, ground walnut shells, coconut shells, and rice husk shells and the like. Additionally, polyfunctional coupling agents such as divinyl benzene, triallyl cyanurate, triallyl iso-cyanurate, urethane di-, tri-, and tetraacrylates and methacrylates, and the like may be added. Such coupling agents can be added to one or more of these additives for easier incorporation into the polymer. For instance, the coupling can be mixed with a plasticizer, e.g., a non-reactive plasticizer, e.g., a citric acid ester, and then compounded with the polymer under conditions to induce branching. Other coupling useful in the compositions of invention, for example, compositions of the first, second, third or fourth aspect are hyperbranched or dendritic polyesters, such as dendritic and hyperbranched acrylates, such as urethane acrylate.

Optionally, additives are included in the blended compositions of the present invention at a concentration of about 0.05 to about 20% by weight of the total composition. For example, the range in certain embodiments is about 0.05 to about 5% of the total composition. The additive is any compound known to those of skilled in the art to be useful in the production of thermoplastics. Exemplary additives include, e.g., plasticizers (e.g., to increase flexibility of a thermoplastic composition), antioxidants (e.g., to protect the thermoplastic composition from degradation by ozone or oxygen), ultraviolet stabilizers (e.g., to protect against weathering), lubricants (e.g., to reduce friction), pigments (e.g., to add color to the thermoplastic composition), flame retardants, fillers, reinforcing, mold release, and antistatic agents. It is well within the skilled practitioner's abilities to determine whether an additive should be included in the blended composition of the present invention and, if so, what additive and the amount that should be added to the composition.

The additive(s) can also be prepared as a masterbatch for example, by incorporating the additive(s) in a PHA or PHA blend and producing pellets of the resultant composition for addition to subsequent processing. In a masterbatch the concentration of the additive(s) is (are) higher than the final amount for the product to allow for proportionate mixing of the additive in the final composition.

In compositions wherein the PHA is poly-3-hydroxybutyrate, for example, plasticizers are often used to change the glass transition temperature and modulus of the composition, but surfactants may also be used. Lubricants may also be used, e.g., in injection molding applications. Plasticizers, surfactants and lubricants may all therefore be included in the overall composition.

In other embodiments, the blend includes one or more plasticizers. Examples of plasticizers include phthalic compounds (including, but not limited to, dimethyl phthalate, diethyl phthalate, dibutyl phthalate, dihexyl phthalate, di-n-octyl phthalate, di-2-ethylhexyl phthalate, diisooctyl phthalate, dicapryl phthalate, dinonyl phthalate, diisononyl phthalate, didecyl phthalate, diundecyl phthalate, dilauryl phthalate, ditridecyl phthalate, dibenzyl phthalate, dicyclohexyl phthalate, butyl benzyl phthalate, octyl decyl phthalate, butyl octyl phthalate, octyl benzyl phthalate, n-hexyl n-decyl phthalate, n-octyl phthalate, and n-decyl phthalate), phosphoric compounds (including, but not limited to, tricresyl phosphate, trioctyl phosphate, triphenyl phosphate, octyl diphenyl phosphate, cresyl diphenyl phosphate, and trichloroethyl phosphate), adipic compounds (including, but not limited to, dibutoxyethoxyethyl adipate (DBEEA), dioctyl adipate, diisooctyl adipate, di-n-octyl adipate, didecyl adipate, diisodecyl adipate, n-octyl n-decyl adipate, n-heptyl adipate, and n-nonyl adipate), sebacic compounds (including, but not limited to, dibutyl sebacate, dioctyl sebacate, diisooctyl sebacate, and butyl benzyl sebacate), azelaic compounds, citric compounds (including, but not limited to, triethyl citrate, acetyl triethyl citrate, tributyl citrate, acetyl tributyl citrate, and acetyl trioctyl citrate), glycolic compounds (including, but not limited to, methyl phthalyl ethyl glycolate, ethyl phthalyl ethyl glycolate, and butyl phthalyl ethyl glycolate), trimellitic compounds (including, but not limited to, trioctyl trimellitate and tri-n- octyl n-decyl trimellitate), phthalic isomer compounds (including, but not limited to, dioctyl isophthalate and dioctyl terephthalate), ricinoleic compounds (including, but not limited to, methyl acetyl, recinoleate and butyl acetyl recinoleate), polyester compounds (including, but not limited to reaction products of diols selected from butane diol, ethylene glycol, propane 1,2 diol, propane 1,3 diol, polyethylene glycol, glycerol, diacids selected from adipic acid, succinic acid, succinic anhydride and hydroxyacids such as hydroxystearic acid, epoxidized soy bean oil, chlorinated paraffins, chlorinated fatty acid esters, fatty acid compounds, plant oils, pigments, and acrylic compounds. The plasticizers may be used either alone respectively or in combinations with each other.

In certain embodiments, the blended polyhydroxyalkanoate/amorphous polyhydroxyalkanoate compositions of the present invention include one or more surfactants. Surfactants are generally used to de-dust, lubricate, reduce surface tension, and/or densify. Examples of surfactants include, but are not limited to mineral oil, castor oil, and soybean oil. One mineral oil surfactant is DRAKEOL® 34 surfactant, available from Penreco (Dickinson, Tex., USA). MAXSPERSE® W-6000 surfactant and W-3000 solid surfactants are available from Chemax Polymer Additives (Piedmont, S.C., USA). Non-ionic surfactants with HLB values ranging from about 2 to about 16 can be used, examples being TWEEN-20 surfactant, TWEEN-65 surfactant, Span-40 surfactant and Span 85 surfactant.

Anionic surfactants include: aliphatic carboxylic acids such as lauric acid, myristic acid, palmitic acid, stearic acid, and oleic acid; fatty acid soaps such as sodium salts or potassium salts of the above aliphatic carboxylic acids; N-acyl-N-methylglycine salts, N-acyl-N-methyl-beta-alanine salts, N-acylglutamic acid salts, polyoxyethylene alkyl ether carboxylic acid salts, acylated peptides, alkylbenzenesulfonic acid salts, alkylnaphthalenesulfonic acid salts, naphthalenesulfonic acid salt-formalin polycondensation products, melaminesulfonic acid salt-formalin polycondensation products, dialkylsulfosuccinic acid ester salts, alkyl sulfosuccinate disalts, polyoxyethylene alkylsulfosuccinic acid disalts, alkylsulfoacetic acid salts, (alpha-olefinsulfonic acid salts, N-acylmethyltaurine salts, sodium dimethyl 5-sulfoisophthalate, sulfated oil, higher alcohol sulfuric acid ester salts, polyoxyethylene alkyl ether sulfuric acid salts, secondary higher alcohol ethoxysulfates, polyoxyethylene alkyl phenyl ether sulfuric acid salts, monoglysulfate, sulfuric acid ester salts of fatty acid alkylolamides, polyoxyethylene alkyl ether phosphoric acid salts, polyoxyethylene alkyl phenyl ether phosphoric acid salts, alkyl phosphoric acid salts, sodium alkylamine oxide bistridecylsulfosuccinates, sodium dioctylsulfosuccinate, sodium dihexylsulfosuccinate, sodium dicyclohexylsulfosuccinate, sodium diamylsulfosuccinate, sodium diisobutylsulfosuccinate, alkylamine guanidine polyoxyethanol, disodium sulfosuccinate ethoxylated alcohol half esters, disodium sulfosuccinate ethoxylated nonylphenol half esters, disodium isodecylsulfosuccinate, disodium N-octadecylsulfosuccinamide, tetrasodium N-(1,2-dicarboxyethyl)-N-octadecylsulfosuccinamide, disodium mono-or didodecyldiphenyl oxide disulfonates, sodium diisopropylnaphthalenesulfonate, and neutralized condensed products from sodium naphthalenesulfonate.

One or more lubricants can also be added to the compositions and methods of the invention. Lubricants are normally used to reduce sticking to hot metal surfaces during processing and can include polyethylene, paraffin oils, and paraffin waxes in combination with metal stearates (e.g., zinc sterate). Other lubricants include stearic acid, amide waxes, ester waxes, metal carboxylates, and carboxylic acids. Lubricants are normally added to polymers in the range of about 0.1 percent to about 5 percent by weight, generally from about 0.7 percent to about 0.1 percent by weight of the compound. Solid lubricants is warmed and melted before or during processing of the blend.

One or more anti-microbial agents can also be added to the compositions and methods of the invention. An anti-microbial is a substance that kills or inhibits the growth of microorganisms such as bacteria, fungi, or protozoans, as well as destroying viruses. Antimicrobial drugs either kill microbes (microbicidal) or prevent the growth of microbes (microbistatic). A wide range of chemical and natural compounds are used as antimicrobials, including but not limited to: organic acids, essential oils, cations and elements (e.g., colloidal silver). Commercial examples include but are not limited to PolySept® Z microbial, UDA and AGION®.

PolySept® Z microbial (available from PolyChem Alloy) is an organic salt based, non-migratory antimicrobial. “UDA” is Urtica dioica agglutinin. AGION® antimicrobial is a silver compound. AMICAL® 48 silver is diiodomethyl p-tolyl sulfone.

In film applications of the blended polyhydroxyalkanoate/amorphous polyhydroxyalkanoate compositions and methods described herein, anti-lock masterbatch is also added. A suitable example is a slip anti-block masterbatch mixture of erucamide (20% by weight) diatomaceous earth (15% by weight) nucleant masterbatch (3% by weight), pelleted into PHA (62% by weight).

### Branched Polyhydroxyalkanoates

The term “branched PHA” refers to a PHA with branching of the chain and/or coupling of two or more chains. Branching on side chains is also contemplated. Branching can be accomplished by various methods. The PHAs described previously can be branched by branching agents by free-radical-induced coupling of the polymer. In certain embodiment, the PHA is branched prior to combination in the method. In other embodiments, the PHA is reacted with peroxide in the methods of the invention. The branching increases the melt strength of the polymer and can impart greater compatibility of the polymeric components of the formulation. PHA can be branched in any of the ways described in U.S. Pat. Nos. 6,620,869, 7,208,535, 6,201,083, 6,156,852, 6,248,862, 6,201,083 and 6,096,810 all of which are incorporated herein by reference in their entirety.

The polymers of the invention can also be branched according to any of the methods disclosed in International Publication No. WO 2010/008447, titled “Methods For Branching PHA Using Thermolysis” or International Publication No. WO 2010/008445, titled “Branched PHA Compositions, Methods for Their Production, and Use in Applications,” both of which were published in English on Jan. 21, 2010, and designated the United States. These applications are incorporated by reference herein in their entirety.

### Branching Agents

The branching agents, also referred to a free radical initiator, for use in the compositions and methods described herein include organic peroxides. Peroxides are reactive molecules, and can react with linear PHA molecules or previously branched PHA by removing a hydrogen atom from the polymer backbone, leaving behind a radical. PHA molecules having such radicals on their backbone are free to combine with each other, creating branched PHA molecules. Branching agents are selected from any suitable initiator known in the art, such as peroxides, azo-dervatives (e.g., azo-nitriles), peresters, and peroxycarbonates. Suitable peroxides for use in the present invention include, but are not limited to, organic peroxides, for example dialkyl organic peroxides such as 2,5-dimethyl-2,5-di(t-butylperoxy) hexane, 2,5-bis(t-butylperoxy)-2,5-dimethylhexane (available from Akzo Nobel as TRIGANOX 101), 2,5-dimethyl-di(t-butylperoxy)hexyne-3, di-t-butyl peroxide, dicumyl peroxide, benzoyl peroxide, di-t-amyl peroxide, t-amylperoxy-2-ethylhexylcarbonate (TAEC), t-butyl cumyl peroxide, n-butyl-4,4-bis(t-butylperoxy)valerate, 1,1-di(t-butylperoxy)-3,3,5-trimethyl-cyclohexane, 1,1-bis(t-butylperoxy)-3,3,5-trimethylcyclohexane (CPK), 1,1-di(t-butylperoxy)cyclohexane, 1,1-di(t-amylperoxy)-cyclohexane, 2,2-di(t-butylperoxy)butane, ethyl-3,3-di(t-butylperoxy)butyrate, 2,2-di(t-amylperoxy)propane, ethyl-3,3-di(t-amylperoxy)butyrate, t-butylperoxy-acetate, t-amylperoxyacetate, t-butylperoxybenzoate, t-amylperoxybenzoate, di-t-butyldiperoxyphthalate, di-(tert-butylperoxyisopropyl) benzene (VulCup®) and the like. Combinations and mixtures of peroxides can also be used. Examples of free radical initiators include those mentioned herein, as well as those described in, e.g., Polymer Handbook, 3rd Ed., J. Brandrup & E. H. Immergut, John Wiley and Sons, 1989, Ch. 2. Irradiation (e.g., e-beam or gamma irradiation) can also be used to generate PHA branching.

The efficiency of branching and coupling of the polymer(s) can also be significantly enhanced by the dispersion of organic peroxides in a coupling agent, such as a polymerizable (i.e., reactive) plasticizers. The polymerizable plasticizer should contain a reactive functionality, such as a reactive unsaturated double bond, which increases the overall branching and coupling efficiency.

As discussed above, when peroxides decompose, they form very high energy radicals that can extract a hydrogen atom from the polymer backbone. These radicals have short half-lives, thereby limiting the population of branched molecules that is produced during the active time period.

### Coupling Agents

Coupling agent, also referred to as co-agents, used in the methods and compositions of the invention are coupling agents comprising two or more reactive functional groups such as epoxides or double bonds. These coupling agents modify the properties of the polymer. These properties include, but are not limited to, melt strength or toughness. One type of coupling agent is an “epoxy functional compound.” As used herein, “epoxy functional compound” is meant to include compounds with two or more epoxide groups capable of increasing the melt strength of polyhydroxyalkanoate polymers by branching, e.g., end branching as described above.

When an epoxy functional compound is used as the coupling agent in the disclosed methods, a branching agent is optional. As such one embodiment of the invention is a method of branching a starting PHA, comprising reacting a starting PHA with an epoxy functional compound and then further blending this PHA with an amorphous polyhydroxyalkanoate. Alternatively, the invention is a method of branching a starting polyhydroxyalkanoate polymer, comprising reacting a starting PHA, a branching agent and an epoxy functional compound and then further blending this PHA with amorphous polyhydroxyalkanoate. Alternatively, the invention is a method of branching a starting polyhydroxyalkanoate polymer, comprising reacting a starting PHA, and an epoxy functional compound in the absence of a branching agent and then further blending this PHA with amorphous polyhydroxyalkanoate. Such epoxy functional compounds can include epoxy-functional, styrene-acrylic polymers (such as, but not limited to, e.g., MP-40 (Kaneka)), acrylic and/or polyolefin copolymers and oligomers containing glycidyl groups incorporated as side chains (poly (ethylene-glycidyl methacrylate-co-methacrylate)), and epoxidized oils (such as, but not limited to, e.g., epoxidized soybean, olive, linseed, palm, peanut, coconut, seaweed, cod liver oils, or mixtures thereof, e.g., Merginat® ESBO (Hobum, Hamburg, Germany) and EDENOL® B 316 (Cognis, Dusseldorf, Germany)).

For example, reactive acrylics or functional acrylics coupling agents are used to increase the molecular weight of the polymer in the branched polymer compositions described herein. Such coupling agents are sold commercially. One such compound is MP-40 (Kaneka) and still another is Petra line from Honeywell, see for example, U.S. Pat. No. 5,723,730. Such polymers are often used in plastic recycling (e.g., in recycling of polyethylene terephthalate) to increase the molecular weight (or to mimic the increase of molecular weight) of the polymer being recycled.

Fatty acid esters or naturally occurring oils containing epoxy groups (epoxidized) and/or chemical unsaturation can also be used. Examples of naturally occurring oils are olive oil, linseed oil, soybean oil, palm oil, peanut oil, coconut oil, seaweed oil, cod liver oil, or a mixture of these compounds. Particular preference is given to epoxidized soybean oil (e.g., Merginat® ESBO from Hobum, Hamburg, or EDENOL® B 316 from Cognis, Dusseldorf), but others may also be used.

Another type of coupling agent are agents with two or more double bonds. Coupling agents with two or more double bond coupling PHAs by after reacting at the double bonds. Examples of these include: diallyl phthalate, pentaerythritol urethane acrylate, tetraacrylate, trimethylolpropane triacrylate, pentaerythritol triacrylate, dipentaerythritol pentaacrylate, diethylene glycol dimethacrylate, bis (2-methacryloxyethyl) phosphate.

In general, it appears that compounds with terminal epoxides may perform better than those with epoxide groups located elsewhere on the molecule.

Compounds having a relatively high number of end groups are the most desirable. Molecular weight may also play a role in this regard, and compounds with higher numbers of end groups relative to their molecular weight (e.g., the Joncryl® resins are in the 3000-4000 g/mol range) are likely to perform better than compounds with fewer end groups relative to their molecular weight (e.g., the Omnova products have molecular weights in the 100,000-800,000 g/mol range).

### Nucleating Agents

For instance, an optional nucleating agent is added to the blended composition to aid in its crystallization. Nucleating agents for various polymers are simple substances, metal compounds including composite oxides, for example, carbon black, calcium carbonate, synthesized silicic acid and salts, silica, zinc white, clay, kaolin, basic magnesium carbonate, mica, talc, quartz powder, diatomite, dolomite powder, titanium oxide, zinc oxide, antimony oxide, barium sulfate, calcium sulfate, alumina, calcium silicate, metal salts of organophosphates, and boron nitride; low-molecular organic compounds having a metal carboxylate group, for example, metal salts of such as octylic acid, toluic acid, heptanoic acid, pelargonic acid, lauric acid, myristic acid, palmitic acid, stearic acid, behenic acid, cerotic acid, montanic acid, melissic acid, benzoic acid, p-tert-butylbenzoic acid, terephthalic acid, terephthalic acid monomethyl ester, isophthalic acid, and isophthalic acid monomethyl ester; high-molecular organic compounds having a metal carboxylate group, for example, metal salts of such as: carboxyl-group-containing polyethylene obtained by oxidation of polyethylene; carboxyl-group-containing polypropylene obtained by oxidation of polypropylene; copolymers of olefins, such as ethylene, propylene and butene-1, with acrylic or methacrylic acid; copolymers of styrene with acrylic or methacrylic acid; copolymers of olefins with maleic anhydride; and copolymers of styrene with maleic anhydride; high-molecular organic compounds, for example: alpha-olefins branched at their 3-position carbon atom and having no fewer than 5 carbon atoms, such as 3,3 dimethylbutene-1,3-methylbutene-1,3-methylpentene-1,3-methylhexene-1, and 3,5,5-trimethylhexene-1; polymers of vinylcycloalkanes such as vinylcyclopentane, vinylcyclohexane, and vinylnorbornane; polyalkylene glycols such as polyethylene glycol and polypropylene glycol; poly(glycolic acid); cellulose; cellulose esters; and cellulose ethers; phosphoric or phosphorous acid and its metal salts, such as diphenyl phosphate, diphenyl phosphite, metal salts of bis(4-tert-butylphenyl) phosphate, and methylene bis-(2,4-tert-butylphenyl)phosphate; sorbitol derivatives such as bis(p-methylbenzylidene)sorbitol and bis(p-ethylbenzylidene)sorbitol; and thioglycolic anhydride, p-toluenesulfonic acid and its metal salts. The above nucleating agents may be used either alone or in combinations with each other. In particular embodiments, the nucleating agent is cyanuric acid. In certain embodiments, the nucleating agent can also be another polymer (e.g., polymeric nucleating agents such as PHB).

In certain embodiments, the nucleating agent is selected from: cyanuric acid, carbon black, mica talc, silica, boron nitride, clay, calcium carbonate, synthesized silicic acid and salts, metal salts of organophosphates, and kaolin. In particular embodiments, the nucleating agent is cyanuric acid.

In various embodiments, where the nucleating agent is dispersed in a liquid carrier, the liquid carrier is a plasticizer, e.g., a citric compound or an adipic compound, e.g., acetylcitrate tributyrate ((CITROFLEX® A4) plasticizer, Vertellus, Inc., High Point, N.C.), or DBEEA (dibutoxyethoxyethyl adipate), a surfactant, e.g., Triton X-100 surfactant, TWEEN-20 surfactant, TWEEN-65 surfactant, Span-40 surfactant or Span 85 surfactant, a lubricant, a volatile liquid, e.g., chloroform, heptane, or pentane, an organic liquid or water.

In other embodiments, the nucleating agent is aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole.

In particular embodiments, the nucleating agent can include aluminum hydroxy diphosphate or a compound comprising a nitrogen-containing heteroaromatic core. The nitrogen-containing heteroaromatic core is pyridine, pyrimidine, pyrazine, pyridazine, triazine, or imidazole. The nucleating agent can be a nucleating agent as described in U.S. Pat. App. Pub. 2005/0209377, by Allen Padwa, which is herein incorporated by reference in its entirety.

Another nucleating agent for use in the blended compositions and methods described herein are milled as described in WO 2009/129499 titled “Nucleating Agents for Polyhydroxyalkanoates,” which was published in English and designated the United States, which is herein incorporated by reference in its entirety. Briefly, the nucleating agent is milled in a liquid carrier until at least 5% of the cumulative solid volume of the nucleating agent exists as particles with a particle size of 5 microns or less. The liquid carrier allows the nucleating agent to be wet milled. In other embodiments, the nucleating agent is milled in liquid carrier until at least 10% of the cumulative solid volume, at least 20% of the cumulative solid volume, at least 30% or at least 40%- 50% of the nucleating agent can exist as particles with a particle size of 5 microns or less, 2 microns or less or 1 micron or less. In alternative embodiments, the nucleating agents is milled by other methods, such as jet milling and the like. Additionally, other methods are utilized that reduce the particle size.

The cumulative solid volume of particles is the combined volume of the particles in dry form in the absence of any other substance. The cumulative solid volume of the particles is determined by determining the volume of the particles before dispersing them in a polymer or liquid carrier by, for example, pouring them dry into a graduated cylinder or other suitable device for measuring volume. Alternatively, cumulative solid volume is determined by light scattering.

Suitable heat stabilizers include, for example, organo phosphites such as triphenyl phosphite, tris-(2,6-dimethylphenyl) phosphite, tris-(mixed mono- and di-nonylphenyl) phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Suitable light stabilizers include, for example, benzotriazoles such as 2-(2-hydroxy-5-methylphenyl) benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Suitable antistatic agents include, for example, glycerol monostearate, sodium stearyl sulfonate, sodium dodecylbenzenesulfonate or the like, or combinations of the foregoing antistatic agents. In one embodiment, carbon fibers, carbon nanofibers, carbon nanotubes, carbon black, or any combination of the foregoing may be used in a polymeric resin containing chemical antistatic agents to render the composition electrostatically dissipative.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from 0.1 to 1.0 parts by weight, based on 100 parts by weight of the total composition, excluding any filler.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB.™ 531); 2-[4,6-bis(2,4-dimethylphenyl)-1,3,5-triazin-2-yl]-5-(octyloxy)-phenol (CYASORB.™ 1164); 2,2′-(1,4-phenylene)bis(4H-3,1-benzoxazin-4-one) (CYASORB.™ UV-3638); 1,3-bis[(2-cyano-3,3-diphenylacryloyl)oxy]-2,2-bis[[(2-cyano-3,3-diphenyl-acryloyl)oxy]methyl]propane (UVINUL® 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenyl-acryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight based on 100 parts by weight of the total composition, excluding any filler.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of from 1 to 10 parts by weight, based on 100 parts by weight based on 100 parts by weight of the total composition, excluding any filler.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl-or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo (a) phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4-biphenyl)-5-(4-t-butylphenyl)-1,3,4-oxadiazole; 2-(4-biphenyl)-6-phenylbenzoxazole-1,3; 2,5-Bis-(4-biphenyl)-1)-1,3,4-oxadiazole; 2,5-bis-(4-biphenyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IRS; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of from 0.1 to 5 parts by weight, based on 100 parts by weight of the total composition, excluding any filler.

Suitable colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), naphthalenetetracarboxylic derivatives, monoazo and diazo pigments, triarylmethanes, aminoketones, bis(styryl)biphenyl derivatives, and the like, as well as combinations including at least one of the foregoing colorants. Colorants are generally used in amounts of from 0.1 to 5 parts by weight, based on 100 parts by weight of the total composition, excluding any filler.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

Additionally, materials to improve flow and other properties may be added to the composition, such as low molecular weight hydrocarbon resins. Particularly useful classes of low molecular weight hydrocarbon resins are those derived from petroleum C5 to C9 feedstock that are derived from unsaturated C5 to C9 monomers obtained from petroleum cracking. Non-limiting examples include olefins, e.g. pentenes, hexenes, heptenes and the like; diolefins, e.g. pentadienes, hexadienes and the like; cyclic olefins and diolefins, e.g. cyclopentene, cyclopentadiene, cyclohexene, cyclohexadiene, methyl cyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

Application of the Blended Polyhydroxyalkanoate/amorphous Polyhydroxyalkanoate Compositions

Provided herein is a method of forming a blended polyhydroxyalkanoate/amorphous polyhydroxyalkanoate composition. The method includes mixing: PHA and an amorphous polyhydroxyalkanoate, optionally in the presence of peroxide and a co-agent, under conditions sufficient to form a blended composition that is capable of forming articles of manufacture having the desired physical and mechanical properties.

In one embodiment, a method is provided for improving the functional characteristics of PHA through the melting and cooling of the amorphous polyhydroxyalkanoate in the presence of PHA, comprising the steps of: (a) providing PHA and an amorphous polyhydroxyalkanoate (b) blending said PHA and amorphous polyhydroxyalkanoate to form a mixture, (c) heating said mixture to between 50° C. and 250° C., and (d) resulting in the PHA and amorphous polyhydroxyalkanoate to be miscible thus effecting functional modifications of the amorphous polyhydroxyalkanoate and PHA wherein the functional modification increases the impact strength, toughness and elongation of the final product.

In another embodiment a method is provided for improving the functional characteristics of PHA through the melting and cooling of the amorphous polyhydroxyalkanoate in the presence of PHA, comprising the steps of: (a) providing PHA an amorphous polyhydroxyalkanoate, a peroxide, and a co-agent (b) blending said PHA, amorphous polyhydroxyalkanoate, peroxide, and co-agent to form a mixture, (c) heating said mixture to between 50° C. and 250° C., thus resulting in the PHA and amorphous polyhydroxyalkanoate to be miscible thus effecting functional modifications of the amorphous polyhydroxyalkanoate and PHA wherein the functional modification increases the impact strength, toughness and elongation of the final product.

In yet another embodiment a method is provided for improving the functional characteristics of PHA through the melting and cooling of the amorphous polyhydroxyalkanoate in the presence of PHA, comprising the steps of: (a) providing PHA an amorphous polyhydroxyalkanoate, a peroxide, and a co-agent (b) blending said PHA, amorphous polyhydroxyalkanoate, peroxide, and co-agent to form a mixture, (c) subjecting the mixture to another blending operation wherein additional peroxide and co-agent are added to the mixture (e) heating said mixture to between 50° C. and 250° C. thus resulting in the PHA and amorphous polyhydroxyalkanoate to be miscible thus effecting functional modifications of the amorphous polyhydroxyalkanoate and PHA wherein the functional modification increases the impact strength, toughness and elongation of the final product.

In yet another embodiment a method is provided for improving the functional characteristics of PHA through the melting and cooling of the amorphous polyhydroxyalkanoate in the presence of PHA, comprising the steps of: (a) providing PHA an amorphous polyhydroxyalkanoate, a peroxide, and a co-agent (b) blending said PHA, amorphous polyhydroxyalkanoate to form a mixture, (c) subjecting the mixture to another blending operation wherein peroxide and co-agent are added to the mixture (e) heating said mixture to between 50° C. and 250° C. thus resulting in the PHA and amorphous polyhydroxyalkanoate to be miscible thus effecting functional modifications of the amorphous polyhydroxyalkanoate and PHA wherein the functional modification increases the impact strength, toughness and elongation of the final product.

In certain embodiments, the blended composition is made by melt mixing the individual components to produce a mixture. The mixture is then used for conversion into fabricated parts through injection molding, sheet and profile extrusion, fiber extrusion, cast film extrusion, blown film extrusion, thermoforming, vacuum forming, blow molding, and roto-molding operations. For film applications the composition of the invention may be the complete film or one or more layers in a multilayer co-extruder composite structure. Alternatively, the blended compositions may form different layers within a coextruded laminate, where each layer has a slightly different composition.

In certain embodiments, the PHA and amorphous polyhydroxyalkanoate components are in the form of a fine particle size powder, the blended composition of the present invention is prepared by dry-blending the components at a pre-determined ratio and subjecting this mixture to twin-screw extrusion.

Additionally, provided herein is a method for forming a blended polymer resin pellet, where the method includes combining: the PHA and amorphous polyhydroxyalkanoate components, where the composition is melted and formed under suitable conditions to form a blended resin pellet.

The novel blended blends described herein can be fabricated into commercially useful articles, such as, but not limited to, films, sheets (including multilayer sheets), molding, cutlery, fiber, nonwovens, filament, monofilaments, rod, tube, bottle, pellet or foam. The article is formed by molding, extruding, thermoforming or blowing of the polyhydroxyalkanoate/amorpohus polyhydroxyalkanoate blended composition.

In any of the compositions, methods, processes or articles described herein, the PHA and amorphous polyhydroxyalkanoate components can be in the form of a fine particle size powder, pellet, or granule and combined by mixing or blending.

For the fabrication of useful articles, the compositions described herein are processed preferably at a temperature above the crystalline melting point of the polymers but below the decomposition point of any of the ingredients (e.g., the additives described above, with the exception of some branching agents) of the polymeric composition. While in heat plasticized condition, the polymeric composition is processed into a desired shape, and subsequently cooled to set the shape and induce crystallization. Such shapes can include, but are not limited to, a fiber, filament, nonwovens, monofilaments, film, sheet, rod, tube, bottle, or other shape. Such processing is performed using any art-known technique, such as, but not limited to, extrusion, injection molding, compression molding, blowing or blow molding (e.g., blown film, blowing of foam), calendaring, rotational molding, casting (e.g., cast sheet, cast film), or thermoforming.

The compositions are used to create, without limitation, a wide variety of useful products, e.g., automotive, consumer durable, construction, electrical, medical, and packaging products all of which can secondarily be used as animal feed. For instance, the polymeric compositions is used to make, without limitation, films (e.g., packaging films, agricultural film, mulch film, erosion control, hay bale wrap, slit film, food wrap, pallet wrap, protective automobile and appliance wrap, etc.), golf tees, caps and closures, agricultural supports and stakes, paper and board coatings (e.g., for cups, plates, boxes, etc.), thermoformed products (e.g., trays, containers, lids, yoghurt pots, cup lids, plant pots, noodle bowls, moldings, etc.), housings (e.g., for electronics items, e.g., cell phones, PDA cases, music player cases, computer cases and the like), bags (e.g., trash bags, grocery bags, food bags, compost bags, etc.), hygiene articles (e.g., diapers, feminine hygiene products, incontinence products, disposable wipes, etc.), coatings for pelleted products (e.g., pelleted fertilizer, herbicides, pesticides, seeds, etc.), injection molded articles (writing instruments, cutlery, such as forks, spoons and knifes, aquarium decorations, disk cases, etc.), solution and spun fibers and melt blown fabrics and non-wovens (threads, yarns, wipes, wadding, disposable absorbent articles), blow moldings (deep containers, bottles, etc.) and foamed articles (cups, bowls, plates, packaging, etc.). The products disclosed above all contain a major component (PHA) which if ingested by an animal can be metabolized by the animal and used as a source of energy. Consequently, the added benefit of the products is that they also serve as a food product for living organisms. The term animal includes all animals including human. Examples of animals are non-ruminants, and ruminants. Ruminant animals include, for example, animals such as sheep, goat, and cattle, e.g. cow such as beef cattle and dairy cows. In a particular embodiment, the animal is a non-ruminant animal. Non-ruminant animals include pet animals, e.g. horses, cats and dogs; mono-gastric animals, e.g. pig or swine (including, but not limited to, piglets, growing pigs, and sows); poultry such as turkeys, ducks and chickens (including but not limited to broiler chicks, layers); fish (including but not limited to salmon, trout, tilapia, catfish and carp); seabirds (including but not limited to seagulls, pelicans, terns) sea animals (including but not limited to whales, turtles, dolphins, sharks) and crustaceans (including but not limited to shrimp and prawn).

Thermoforming is a process that uses films or sheets of thermoplastic. The polymeric composition is processed into a film or sheet. The sheet of polymer is then placed in an oven and heated. When soft enough to be formed it is transferred to a mold and formed into a shape.

During thermoforming, when the softening point of a semi-crystalline polymer is reached, the polymer sheet begins to sag. The window between softening and droop is usually narrow. It can therefore be difficult to move the softened polymer sheet to the mold quickly enough. Branching the polymer can be used to increase the melt strength of the polymer so that the sheet maintains is more readily processed and maintains its structural integrity. Measuring the sag of a sample piece of polymer when it is heated is therefore a way to measure the relative size of this processing window for thermoforming.

Blow molding, which is similar to thermoforming and is used to produce deep draw products such as bottles and similar products with deep interiors, also benefits from the increased elasticity and melt strength and reduced sag of the polymer compositions described herein.

The specific examples below are to be construed as merely illustrative, and not limitative of the remainder of the disclosure in any way whatsoever. Without further elaboration, it is believed that one skilled in the art can, based on the description herein, utilize the present invention to its fullest extent. All publications cited herein are hereby incorporated by reference in their entirety.

This invention allows for the production of polymer blends with high amounts of bio-based carbon and with an advantageous balance of desirable physical properties. Specifically, high impact properties (as measured by the notched Izod test), and high flexural modulus without inducing brittleness.

Having disclosed several embodiments, it will be recognized by those of skilled in the art that various modifications, alternative constructions, and equivalents may be used without departing from the spirit of the disclosed embodiments. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the dielectric material” includes reference to one or more dielectric materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A biodegradable polymer composition comprising a polymer blend, said polymer blend comprising: PHA and an amorphous polymer wherein: the content of PHB in the PHA blend is in the range of 70% to 97.5% by weight of the combined content of the PHAs in the PHA blend, the content of aPHA in the PHA blend is in the range of 2.5% to 30% by weight of the combined content of the PHAs in the PHA blend.

2. The biodegradable polymer composition of claim 1, wherein said amorphous polymer is a PHA having a glass transition temperature (Tg) less than 20° C., and a melting temperature (TM) of 80° C. to 180°,

3. The biodegradable polymer composition of claim 1, further comprising: a nucleating agent; a free radical initiator, a branching agent, a coupling agent/coagent, thermal stabilizers, antioxidants, slip agents, colorants and other functional additives.

4. The biodegradable polymer composition of claim 1, wherein said PHA is selected from a poly (3-hydroxybutyrate) homopolymer (PHB), polyhydroxyvalerate (PHV), polyhydroxybutyrate-covalerate (PHBV), polyhydroxyhexanoate (PHHx), poly 3-hydroxyalkanoates (e.g., poly 3-hydroxypropionate (hereinafter referred to as P3HP), poly 3-hydroxybutyrate (hereinafter referred to as PHB) and poly 3-hydroxyvalerate), poly 4-hydroxyalkanoates (e.g., poly 4-hydroxybutyrate (hereinafter referred to as P4HB), or poly 4-hydroxyvalerate (hereinafter referred to as P4HV)) and poly 5-hydroxyalkanoates (e.g., poly 5-hydroxyvalerate (hereinafter referred to as P5HV)), poly 3-hydroxybutyrate-co-3-hydroxypropionate (hereinafter referred to as PHB3HP), poly 3-hydroxybutyrate-co-4-hydroxybutyrate (hereinafter referred to as PHB4HB), poly 3-hydroxybutyrate-co-4-hydroxyvalerate (hereinafter referred to as PHB4HV), poly 3-hydroxybutyrate-co-3-hydroxyvalerate (hereinafter referred to as PHB3HV), poly 3-hydroxybutyrate-co-3-hydroxyhexanoate (hereinafter referred to as PHB3HH) and poly 3-hydroxybutyrate-co-5-hydroxyvalerate (hereinafter referred to as PHB5HV) and various combinations thereof, including polymer blends.

5. A bio-degradable and bio-compostable article made of the polymer composition of claim 1.

6. A durable, injection moldable material made of the polymer composition of claim 1.

7. A thermoformed material made of the polymer composition of claim 1.

8. The biodegradable polymer composition of claim 3, wherein said branching agent is selected from the group consisting of peroxides, azo-dervatives, peresters, and peroxycarbonates.

9. The biodegradable polymer composition of claim 3, wherein said a free radical initiator is selected from the group consisting of organic peroxides.

10. The biodegradable polymer composition of claim 9, wherein said organic peroxide is selected from the group consisting of dialkyl organic peroxides.

11. The biodegradable polymer composition of claim 10, wherein said dialkyl organic peroxides is selected from the group consisting of 2,5-dimethyl-2,5-di(t-butylperoxy) hexane, 2,5-bis(t-butylperoxy)-2,5-dimethylhexane, 2,5-dimethyl-di(t-butylperoxy)hexyne-3, di-t-butyl peroxide, dicumyl peroxide, benzoyl peroxide, di-t-amyl peroxide, t-amylperoxy-2-ethylhexylcarbonate (TAEC), t-butyl cumyl peroxide, n-butyl-4,4-bis(t-butylperoxy)valerate, 1,1-di(t-butylperoxy)-3,3,5-trimethyl-cyclohexane, 1,1-bis(t-butylperoxy)-3,3,5-trimethylcyclohexane (CPK), 1,1-di(t-butylperoxy)cyclohexane, 1,1-di(t-amylperoxy)-cyclohexane, 2,2-di(t-butylperoxy)butane, ethyl-3,3-di (t-butylperoxy)butyrate, 2,2-di(t-amylperoxy)propane, ethyl-3,3-di(t-amylperoxy)butyrate, t-butylperoxy-acetate, t-amylperoxyacetate, t-butylperoxybenzoate, t-amylperoxybenzoate, di-t-butyldiperoxyphthalate, Recommend including di-(tert-butylperoxyisopropyl)benzene (dicumyl peroxide) (VulCup®) and combinations and mixtures.

12. The biodegradable polymer composition of claim 1, wherein said coupling agents is selected from the group consisting of divinyl benzene, triallyl cyanurate, triallyl iso- cyanurate, hyperbranched or dendritic polyesters, such as dendritic and hyperbranched acrylates, such as urethane acrylate.

13. The biodegradable polymer composition of claim 3, wherein said slip agent is selected from the group consisting of stearic acid, amide waxes, ester waxes, metal carboxylates, and carboxylic acids.

14. The biodegradable polymer composition of claim 1, further comprises a functional additive.

15. The biodegradable polymer composition of claim 14, where said functional additive comprises colorants (including carbon black), nucleating agents, stabilizers, coupling agents, processing aids, and strengthening agents.

16. A thermoformed shapeable article for a food product comprising:
polyhydroxyalkanoate (PHA), an amorphous PHA (aPHA), a peroxide, and a coupling agent.

17. A food product formed in the shape of cutlery comprising: a continuous phase and a discrete phase wherein said continuous phase is made up of polyhydroxyalkanoate (PHA) and said discrete phase is an aPHA.

18. A food product formed in the shape of a drinking straw comprising: a continuous phase and a discrete phase wherein said continuous phase is made up of polyhydroxyalkanoate (PHA) and said discrete phase is amorphous PHA.
